(19) United States
(12) Patent Application Publication
(10) Pub. No.: US 2011/0216045 A1
(43) Pub. Date: Sep. 8, 2011

(54) PORTABLE TERMINAL AND METHOD FOR DRIVING SAME

(75) Inventor: Kenichiro Tsuchida, Osaka-shi (JP)

(73) Assignee: Sharp Kabushiki Kaisha, Osaka-shi, Osaka (JP)

(21) Appl. No.: 12/998,572

(22) PCT Filed: Aug. 6, 2009
(86) PCT No.: PCT/JP2009/063953

§ 371 Date: May 4, 2011

(30) Foreign Application Priority Data
Dec. 1, 2008 (JP) 2008-306534

(51) Int. Cl. G09G 3/36; G09G 5/00

(52) U.S. Cl. 345/204; 345/87

(57) ABSTRACT

A PDA (portable terminal) including a display section for displaying information is provided with a first case (lid section) provided so as to be opened/closed with respect to the display section, a rotating mechanism for causing an opening angle between the display section and the first case to be changed, an opening angle detection section for detecting the opening angle, and a display control section (control unit) for changing the information displayed on the display section in accordance with the detection result from the opening angle detection section.

### TECHNICAL FIELD

The present invention relates to a portable terminal configured so as to be used portably, and in particular, to a portable terminal having a display section for displaying information and being configured so as to be opened/dosed (folded) and a method for driving the portable terminal.

### BACKGROUND ART

Recently, in portable terminals which users can carry, a wide variety of products such as mobile telephones, personal digital assistants (PDAs), and game machines have been developed and put into practical use. Such a portable terminal has a display section for displaying information such as characters and images, and further, a liquid crystal panel that is a flat display panel having a number of features such as thinness and light weight generally is used in the display section.

Further, as a conventional portable terminal, a mobile telephone having a liquid crystal display device forming a display section and a rotating mechanism for holding the liquid crystal display device in a case rotatably in a vertical direction or verticallhorizontal direction has been proposed, for example, as described in the following Patent Document 1. Further, in the conventional portable terminal, information can be displayed at an optimum viewing angle in a rotation angle of the liquid crystal display device by setting an angle sensor for detecting a rotation angle of the liquid crystal display device and changing a drive voltage value of the liquid crystal display device in accordance with the detection result from the angle sensor.

### PRIOR ART DOCUMENT

Patent document

Patent Document 1: JP 2006-165668 A

### DISCLOSURE OF INVENTION

Problem to be Solved by the Invention

The above-mentioned conventional portable terminal is configured so that various applications such as a telephone function, an electronic mail function, a game function, or an electronic dictionary function can be executed, and while such applications are being executed, information can be displayed as appropriate on the liquid crystal display device (display section) with respect to a user.

However, the above-mentioned conventional portable terminal has a problem that the functionality of the applications cannot be enhanced easily using the information display with respect to a user.

Specifically, in the above-mentioned conventional portable terminal, the viewing angle of the liquid crystal display device merely is adjusted in accordance with the rotation angle detected by the angle sensor, and even if the viewing angle is adjusted, the information to be displayed on the liquid crystal display device is not changed and the same information remains being displayed. Therefore, in the conventional portable terminal, even if a user moves the portable terminal so that a visible angle with respect to the liquid crystal display device is changed, for example, when the user is executing a game, the display information of the liquid crystal display device is not changed. Consequently, in the conventional portable terminal, entertainment values of games such as interest and realism cannot be enhanced using the information display with respect to the user.

Further, in the conventional portable terminal, when a user operates a button operation generally while executing, for example, the electronic dictionary function, information indicating the meaning of a word and information indicating exemplary sentences using the word are changed, for example. Thus, in the conventional portable terminal, information desired by the user may not be displayed easily, and the operability of the electronic dictionary function cannot be enhanced, using information display with respect to the user.

In view of the above problem, an object of the present invention is to provide a portable terminal capable of enhancing the functionality of applications easily using information display with respect to a user, and a method for driving the portable terminal.

Means for Solving Problem

In order to achieve the above-mentioned object, the present invention relates to a portable terminal having a display section for displaying information, including: a lid section provided so as to be opened/dosed with respect to the display section; a rotating mechanism that is provided with a rotation shaft to which at least one of the display section and the lid section is attached integrally so that the display section and the lie section are capable of rotating relative to each other and that changes an opening angle between the display section and the lid section by rotating at least one of the display section and the lid section;

an opening angle detection section for detecting the opening angle; and

a control section for changing display information displayed on the display section, based on a detection result from the opening angle detection section.

In the portable terminal configured as described above, the rotating mechanism for changing an opening angle between the display section and the lid section is provided and the opening angle detection section for detecting the opening angle is set. Further, the control section changes display information displayed on the display section, based on the detection result from the opening angle detection section. Consequently, the user can change display information in the display section easily by rotating at least one of the display section and the lid section without performing an operation such as a button operation. As a result, unlike the above conventional example, a portable terminal capable of enhancing the function of an application easily can be configured using information display with respect to the user.

Further, in the above-mentioned portable terminal, it is preferred that the display section includes a display device for information display for displaying information and a viewing angle control device for viewing angle control for controlling a viewing angle, and

the control section changes at least one of information displayed by the display device and a viewing angle controlled by the viewing angle control device, based on the detection result from the opening angle detection section.

In this case, even when the opening angle is small, the display information in the display section can be changed exactly in such a manner that the user can visually identify the display information.

Further, in the above-mentioned portable terminal, the display section may be configured as a first display section, and

the lid section may be provided with a second display section configured so as to display information independently from the first display section.

In this case, the function of an application can be enhanced further easily, using each of the first and second display sections.

Further, in the above-mentioned portable terminal, it is preferred that the control section changes display information displayed on the second display section, based on the detection result from the opening angle detection section.

In this case, the function of an application can be enhanced exactly, using the display information in the second display section.

Further, in the above-mentioned portable terminal, it is preferred that the second display section includes a display device for information display for displaying information and a viewing angle control device for viewing angle control for controlling a viewing angle,

the control section changes at least one of information displayed by the display device included in the second display section and a viewing angle controlled by the viewing angle control device induded in the second display section, based on the detection result from the opening angle detection section.

In this case, even when the opening angle is small, the display information in the second display section can be changed exactly in such a manner that the user can visually identify the display information.

Further, in the above-mentioned portable terminal, it is preferred that a liquid crystal panel is usedin each of the display device and the viewing angle control device in each of the first and second display sections.

In this case, a compact portable terminal of high performance can be configured easily.

Further, in the above-mentioned portable terminal, the opening angle detection section may include an angle sensor for detecting a rotation angle of the rotation shaft as the opening angle.

In this case, the opening angle detection section can detect an opening angle with an angle sensor precisely.

Further, in the above-mentioned portable terminal, the opening angle detection section may include a bridge member set so as to rotate integrally with the rotation shaft on an outer circumferential surface side of the rotation shaft, and a plurality of groups of pairs of contact members provided at positions different from each other along a circumferential direction of the rotation shaft on an outer periphery of the rotation shaft and set so as to come into electrical contact with the bridge member.

In this case, the opening angle detection section can detect the opening angle precisely, based on the positions of a pair of contact members that are in electrical contact with the bridge member.

Further, a method for driving a potable terminal of the present invention is a method for driving a portable terminal including a display section for displaying information, a lid section provided so as to be opened/dosed with respect to the display section, and a rotating mechanism that is provided with a rotation shaft to which at least one of the display section and the lid section is attached integrally so that the display section and the lid section are capable of rotating relative to each other and that changes an opening angle between the display section and the lid section by rotating at least one of the display section and the lid section. The method includes:

an opening angle detection step of detecting the opening angle; and

a display information change step of changing display information displayed on the display section, based on the opening angle detected in the opening angle detection step.

A driving program of a portable terminal of the present invention is a driving program of a portable terminal for causing a computer to execute a method for driving a portable terminal including a display section for displaying information, a lid section provided so as to be opened/dosed with respect to the display section, and a rotating mechanism that is provided with a rotation shaft to which at least one of the display section and the lid section is attached integrally so that the display section and the lid section are capable of rotating relative to each other and that changes an opening angle between the display section and the lid section by rotating at least one of the display section and the lid section. The method causes the computer to execute:

an opening angle detection step of detecting the opening angle; and

a display information change step of changing display information displayed on the display section, based on the opening angle detected in the opening angle detection step.

According to the method for driving a portable terminal and the driving program of a portable terminal of the present invention configured as described above, at least one of the display section and the lid section is rotated, whereby the opening angle is detected. Further, in the display section, display information is changed based on the detected opening angle. Thus, a portable terminal can be configured, which is capable of enhancing the function of an application easily, using information display with respect to the user.

Further, in the above-mentioned method for driving a portable terminal, it is preferred that the display information change step includes a viewing angle change step of changing a viewing angle of the display section.

Further, in the above-mentioned driving program of a portable terminal, it is preferred that the display information change step includes a viewing angle change step of changing a viewing angle of the display section.

According to the method for driving a portable terminal and the driving program of a portable terminal configured as described above, even when the opening angle is small, display information in the display section can be changed exactly in such a manner that the user can visually identify the display information.

Effects of the Invention

According to the present invention, a portable terminal capable of enhancing the functionality of applications easily using information display with respect to a user and a method for driving the portable terminal can be provided.

### BRIEF DESCRIPTION OF DRAWINGS

FIG. 1 is a perspective view illustrating a PDA according to Embodiment 1 of the present invention.

FIGS. 2A and 2B are side views of the PDAin a state where first and second cases illustrated in FIG. 1 are opened at different opening angles.

FIGS. 3A and 3B are views illustrating specific examples of display information being displayed on a display section illustrated in FIG. 1 in the state illustrated respectively in FIGS. 2A and 2B.

FIG. 4 is a block diagram illustrating configurations of main sections of the PDA.

FIG. 5 is a view illustrating a specific configuration example of the display section.

FIG. 6 is a block diagram illustrating a specific configuration example of a display control section illustrated in FIG. 4.

FIG. 7A is a view illustrating a specific configuration example of an opening angle detection section illustrated in FIG. 4, and FIG. 7B is a plan view illustrating a configuration of a disc with a slit illustrated in FIG. 7A

FIG. 8 is a flowchart illustrating an operation example of the PDA.

FIG. 9 is a view illustrating a specific configuration example of an opening angle detection section used in a PDA according to Embodiment 2 of the present invention.

FIG. 10 is a perspective view illustrating a PDA according to Embodiment 3 of the present invention.

FIGS. 11A and 11B are side views of the PDA illustrated in FIG. 10 in a state where first and second cases illustrated in FIG. 10 are opened at different opening angles.

FIGS. 12A and 12B are views illustrating specific examples of display information displayed respectively on second and first display sections illustrated in FIG. 9 in the state illustrated in FIG. 11A, and FIGS. 12C and 12D are views illustrating specific examples of display information being displayed respectively on second and first display sections illustrated in FIG. 10 in the state illustrated in

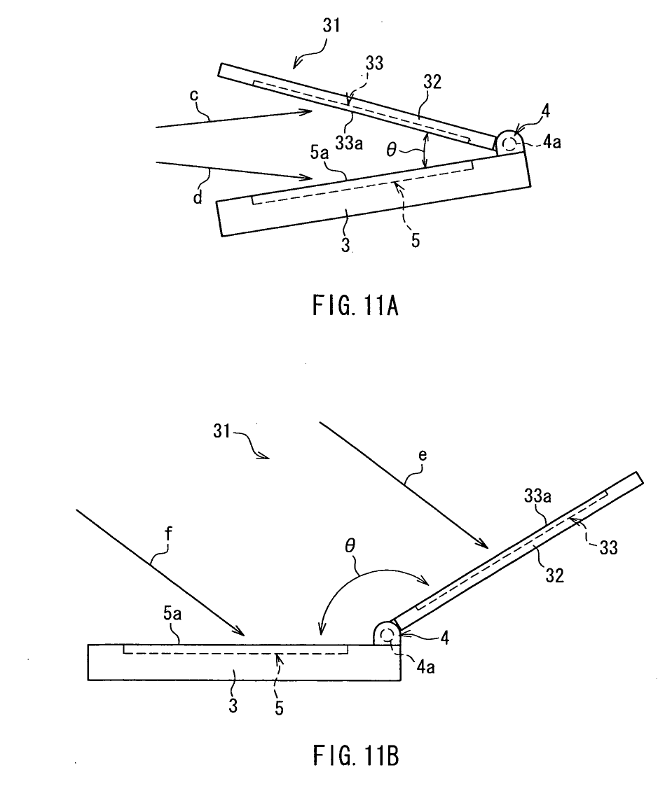

FIG. 11B.

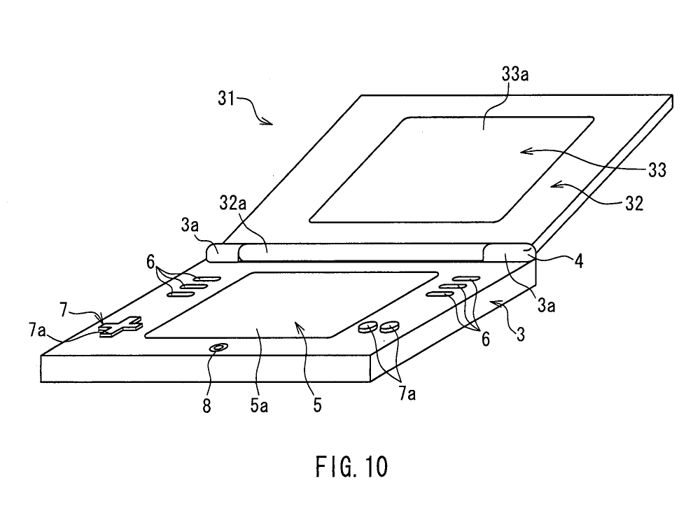

FIG. 13 is a block diagram illustrating a configuration of main sections of the PDAillustrated in FIG. 10.

FIG. 14 is a view illustrating a specific configuration example of the second display section.

FIG. 15 is a block diagram illustrating a specific configuration example of the display control section illustrated in FIG. 13.

FIG. 16 is a flowchart illustrating an operation example of the PDA illustrated in FIG. 10.

### DESCRIPTION OF THE INVENTION

Hereinafter, preferred embodiments showing a portable terminal of the present invention and a method for driving the portable terminal will be described with reference to the drawings. The following description will be made exemplifying the case where the present invention is applied to a personal digital assistant (PDA). Further, the dimensions of constituent members in each figure do not faithfully reflect actual dimensions of the constituent members, dimension ratios of the respective constituent members, etc.

### Embodiment 1

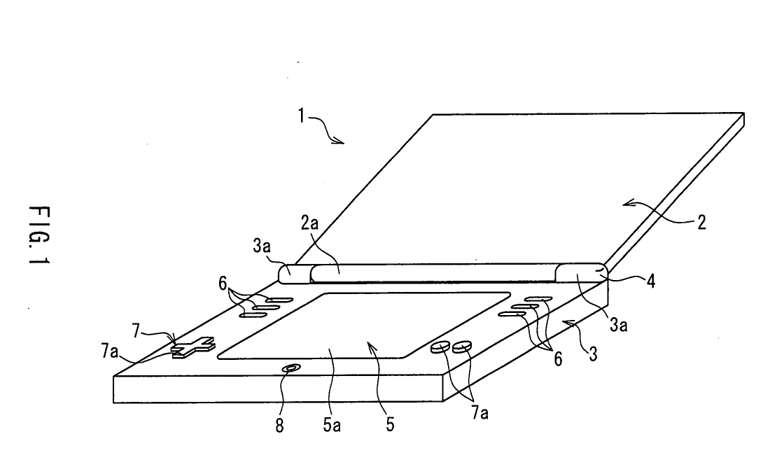

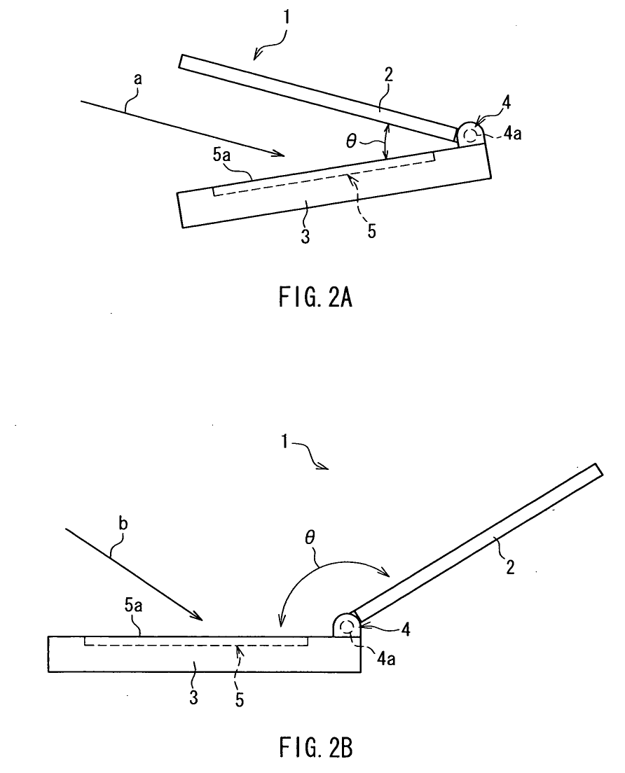

FIG. 1 is a perspective view illustrating a PDA according to Embodiment 1 of the present invention. FIGS. 2A and 2B are side views of the PDAin a state where first and second cases illustrated in FIG. 1 are opened at different opening angles.

In FIG. 1, a PDA 1 of the present embodiment includes a first case 2 and a second case 3, and the first and second cases 2, 3 are configured so as to rotate relative to each other via a rotating mechanism 4 provided at the center of the PDA 1. Specifically, in the PDA 1 of the present embodiment, an end portion 2a of the first case 2 and end portions 3a of the second case 3 are attached integrally to a rotation shaft 4a (FIG. 2) provided at the rotating mechanism 4, and the first and second cases 2 and 3 can rotate around the rotation shaft 4a of the rotating mechanism 4 configured in a hinge structure. Then, in the PDA 1 of the present embodiment, the first and second cases 2, 3 can be opened/dosed (folded) via the rotating mechanism 4.

Specifically, as illustrated in FIGS. 2A and 2B, the PDA 1 of the present embodiment is configured so as to be used while the first and second cases 2, 3 are opened at an opening angle θ. The opening angle corresponds to an angle between the surface of the first case 2 and the surface of the second case 3, and values in a specific angle range of the opening angle θ are, for example, 0° to 150°. Further, the PDA 1 is not used when the opening angle θ is 0°, i.e., in the case where the first and second cases 2, 3 are closed (folded) so that the surface of the first case 2 and the surface of the second case 3 are in contact with each other.

Further, as illustrated in FIG. 1, the second case 3 contains a display section 5 displaying information such as characters and images. The display section 5 includes a display surface 5a provided in a direction perpendicular to the rotation shaft 4a (FIG. 2) so that the information is displayed on the display surface 5a. Further, as described later in detail, the display section 5 includes a display device for information display that displays information and a viewing angle control device for viewing angle control for controlling a viewing angle, and thus, is configured so as to change (control) a viewing angle.

Further, the second case 3 is provided with a speaker 6 that outputs a voice to a user. Further, the second case 3 is provided with an operation section 7 having predetermined operation buttons 7a such as an arrow key and a power supply button. Further, the second case 3 has a microphone 8 through which a user's voice is input.

Further, the first case 2 forms a lid section provided so as to be opened/dosed with respect to the display section 5. Further, when the opening angle θ is 0°, the first case 2 overlaps the second case 3 while covering the display section 5, the operation section 7, and the like provided on the surface side of the second case 3, so as to protect constituent elements provided on the surface side of the second case 3 such as the display section 5 and the operation section 7.

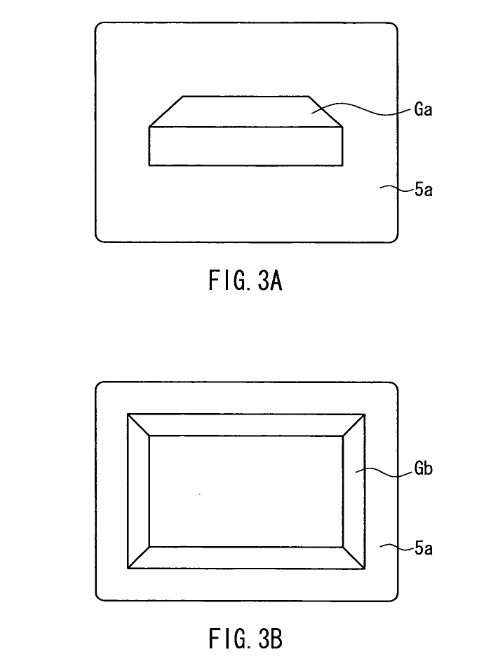

Further, the PDA 1 of the present embodiment is configured in such a manner that the opening angle θ is detected automatically by an opening angle detection section described later, and display information to be displayed on the display section 5 can be changed depending upon the detected opening angle θ. Specifically, as illustrated in FIG. 2A, when the user sees the display surface 5a of the display section 5 from the direction indicated by an arrow “a” in FIG. 2A in the case where the first and second cases 2, 3 are opened at a relatively small opening angle θ, a box Ga with a lid dosed is displayed on the display surface 5a, as illustrated in FIG. 3A. On the other hand, as illustrated in FIG. 2B, when the user sees the display surface 5a of the display section 5 from the direction indicated by an arrow “b” in FIG. 2B in the case where the first and second cases 2, 3 are opened at a relatively large angle θ, a box Gb with the lid removed and the inside thereof shown is displayed on the display surface 5a, as illustrated in FIG. 3B.

As described above, in the PDA 1 of the present embodiment, the display information in the display section 5 can be changed depending upon the opening angle θ, and the PDA 1 is configured so that the function of an application under execution in the PDA 1 can be enhanced easily. Further, the display information in the display section 5 is changed by driving at least one of the display device and the viewing angle control device, as described later in detail.

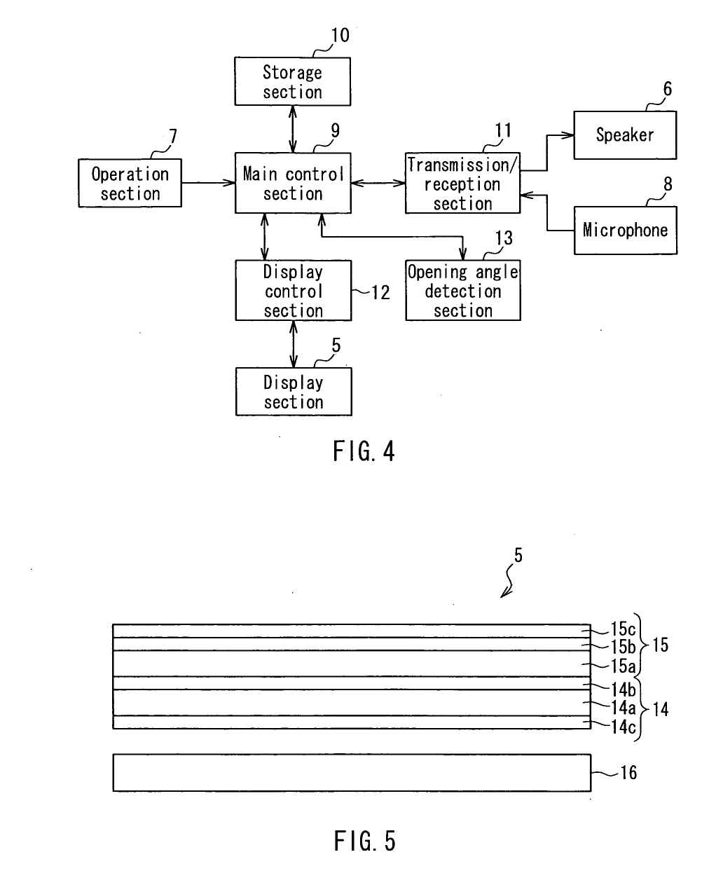

Hereinafter, the PDA 1 of the present embodiment will be described specifically with reference to FIGS. 4 to 7.

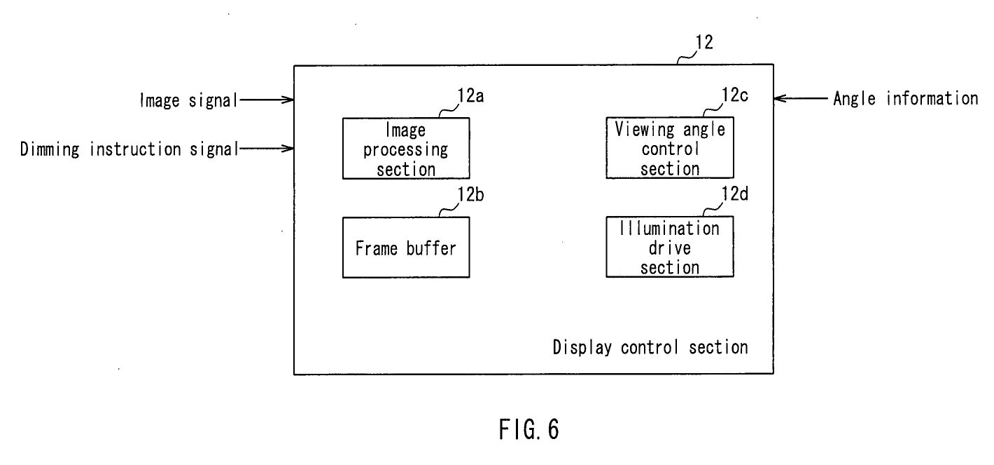

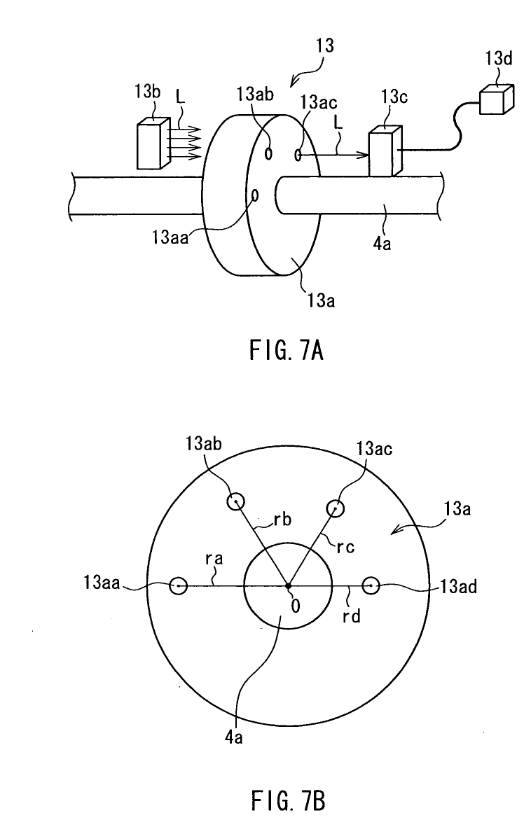

FIG. 4 is a block diagram illustrating configurations of main sections of the PDA FIG. 5 is a view illustrating a specific configuration example of the display section, and FIG. 6 is a block diagram illustrating a specific configuration example of the display control section illustrated in FIG. 4. FIG. 7A is a view illustrating a specific configuration example of an opening angle detection section illustrated in FIG. 4, and FIG. 7B is a plan view illustrating a configuration of a disc with a slit illustrated in FIG. 7A.

First, the configurations of main sections of the PDA 1 of the present embodiment will be described with reference to FIG. 4.

As illustrated in FIG. 4, the PDA 1 of the present embodiment includes a main control section 9, a storage section 10 including a memory storing various data, and a transmission/reception section 11 for transmitting/receiving a voice, connected to the speaker 6 and the microphone 8. Further, the PDA 1 indudes a display control section 12 for driving the display section 5, and an opening angle detection section 13 for detecting the opening angle θ between the first and second cases 2, 3.

The main control section 9 is composed of a CPU, an MPU, and the like, and drives each section of the PDA 1 in an integrated manner. Further, the main control section 9 is adapted to execute a predetermined application provided to the PDA 1, using a program stored previously in the storage section 10. Specifically, the main control section 9 reads a corresponding program from the storage section 10 in accordance with a user's request indicated via the operation section 7 and causes the program to execute a predetermined application such as a game function, an electronic dictionary function, a telephone function, an electronic mail function, or an Internet function. The storage section 10 is adapted to appropriately hold data such as a program downloaded via an antenna (not shown) and the transmission/reception section 11, and the main control section 9 is adapted to drive each section of the PDA 1 based on the downloaded data.

The display control section 12 is configured so as to drive the display section 5 based on an instruction signal from the main control section 9. Further, the display control section 12 forms a control unit that changes display information to be displayed on the display section 5, based on the detection result from the opening angle detection section 13. Specifically, the display control section 12 is adapted to drive at least one of the display device and the viewing angle control device in accordance with the opening angle 6 detected by the opening angle detection section 13 so as to change the display information in the display section 5.

Further, the display control section 12 is configured so as to drive at least the viewing angle control device to change the viewing angle of the display section 5 in the case where the opening angle θ detected by the opening angle detection section 13 is a predetermined angle (e.g., 30°) or less.

As described later in detail, the opening angle detection section 13 includes an angle sensor detecting the rotation angle of the rotation shaft 4a as the opening angle θ. Then, in the case where the rotating mechanism 4 changes the opening angle θ between the first and second cases 2, 3, the opening angle detection section 13 detects the opening angle θ and outputs it to the main control section 9.

Besides the above-mentioned description, the display control section 12 and the opening angle detection section 13 may be connected to each other so that the detection result from the opening angle detection section 13 can be input directly to the display control section 12.

Next, the specific configuration of the display section 5 will be described with reference to FIG. 5.

As illustrated in FIG. 5, the display section 5 includes a liquid crystal display device 14 as the above-mentioned display device, the viewing angle control device 15 provided integrally with the liquid crystal display device 14 and set on a side of the display surface 5a (FIG. 1), and an illumination device 16 emitting predetermined illumination light to the liquid crystal display device 14.

The liquid crystal display device 14 includes a liquid crystal panel 14a for display and a pair of polarizing plates 14b and 14c provided respectively on a display surface side and a non-display surface side of the liquid crystal panel 14a. The liquid crystal panel 14a has a display surface that displays information containing characters and images and substantially forms the display surface 5a. Further, the liquid crystal panel 14a is provided with a color filter (not shown) so as to perform a color display.

Any liquid crystal mode and pixel structure can be adopted in the liquid crystal panel 14a. Further, any drive mode can be adopted in the liquid crystal panel 14a. Specifically, as the liquid crystal panel 14a, any liquid crystal panel capable of displaying information can be used. Therefore, in FIG. 5, the detailed structure of the liquid crystal panel 14a is not shown, and the description thereof is omitted.

The viewing angle control device 15 includes a liquid crystal panel 15a for controlling a viewing angle to be placed on the polarizing plate 14b, and a retardation plate 15b and a polarizing plate 15c laminated successively on the liquid crystal panel 15a.

The liquid crystal panel 15a includes a liquid crystal layer and a pair of light-transparent substrates sandwiching the liquid crystal layer (not shown). Further, in the liquid crystal panel 15a, it is not necessary to drive the liquid crystal layer on a pixel basis, unlike the liquid crystal panel 14a, and hence, there is no limit to an electrode structure. That is, in the liquid crystal panel 15a, in order to perform uniform switching over the entire display surface, a uniform transparent electrode may be formed over the entire surface of the transparent substrate or any other electrode structure may be adopted.

Further, the viewing angle control device 15 is configured so as to change the viewing angle of the display section 5 in an opening direction, in cooperation with the polarizing plate 14b of the liquid crystal display device 14. That is, the polarizing plate 15c and the polarizing plate 14b are placed so that the respective polarization transmission axes are substantially orthogonal to each other (e.g., in a range of 80° to 100°).

Specifically, in the viewing angle control device 15, when a voltage is applied to the liquid crystal panel 15a, liquid crystal molecules (not shown) in a liquid crystal layer provided in the liquid crystal panel 15a tilt depending upon the magnitude of the voltage. Thus, the viewing angle is changed in the display section 5, and the user can visually identify and read information displayed on the display section 5, even when the first and second cases 2 and 3 are opened at a very small opening angle θ equal to or lower than the above-mentioned predetermined angle (30° or less). That is, for example, even in the case where the user visually identifies the display section 5 in a direction indicated by the arrow “a” in FIG. 2A, the user can determine the information displayed on the display section 5 when the viewing angle control device 15 controls (changes) the viewing angle of the display section 5 appropriately.

On the other hand, in the case where a voltage is not applied to the liquid crystal panel 15a, when a birefringence sufficient for obtaining a satisfactory display with respect to every direction from the display surface 5a is generated in the liquid crystal panel 15a, the display section 5 is allowed to have a large viewing angle.

As described above, in the display section 5 of the present embodiment, the viewing angle of the display section 5 can be changed by switching application/non-application of a voltage to the liquid crystal panel 15a.

The illumination device 16 is formed of, for example, an edge light type backlight having an LED (not shown) as a light source and a light guide plate (not shown) that guides light from the LED in a predetermined direction and outputs the light as illumination light to the liquid crystal display device 14 side.

Next, a specific configuration of the display control section 12 will be described with reference to FIG. 6.

As illustrated in FIG. 6, the display control section 12 is adapted to receive an image signal, a dimming instruction signal, and angle information from the main control section 9 (FIG. 4). Further, the display control section 12 includes an image processing section 12a for performing predetermined image processing and a frame buffer 12b capable of storing one frame of display data contained in an input image signal. In the display control section 12, the image processing section 12a performs predetermined image processing with respect to an input image signal, whereby an instruction signal is generated and output to the liquid crystal panel 14a (FIG. 5) of the liquid crystal display device 14. Thus, in the liquid crystal panel 14a, information display in accordance with an image signal is performed.

Further, the display control section 12 is configured so that the image processing section 12a is capable of changing information displayed by the liquid crystal display device 14 (FIG. 5) based on the detection result from the opening angle detection section 13. Specifically, in the main control section 9, an image signal is changed appropriately and output to the display control section 12 in accordance with the detection result from the opening angle detection section 13, and the image processing section 12a is capable of allowing information display in accordance with the detection result to be performed by the liquid crystal panel 14a.

Further, the display control section 12 is provided with a viewing angle control section 12c for driving the viewing angle control device 15 (FIG. 5) based on angle information (that is, the detection results from the opening angle detection section 13) input from the main control section 9. That is, the viewing angle control section 12c drives the viewing angle control device 15 so that the viewing angle of the display section 5 (FIG. 1) is changed in accordance with the opening angle θ detected by the opening angle detection section 13.

Further, the display control section 12 is provided with an illumination drive section 12d for driving the illumination device 16 based on the dimming instruction signal input from the main control section 9. That is, the illumination drive section 12d is configured so as to change the brightness of illumination light output from the illumination device 16 in accordance with the input dimming instruction signal, and the information display can be performed in the display section 5 at brightness desired by the user.

Next, referring to FIG. 7, a specific configuration of the opening angle detection section 13 will be described. In the following description, for simplicity of the description, the case where the opening angle detection section detects four opening angles of 10°, 30°, 90°, and 150° in stages will be described (the same also applies to each of the second and third embodiments described later).

In FIG. 7A, the opening angle detection section 13 includes an angle sensor utilizing laser light L, and is configured so that a rotation angle of the rotation shaft 4a is detected as the above-mentioned opening angle by the angle sensor. Specifically, also referring to FIG. 7B, the opening angle detection section 13 is attached integrally to the rotation shaft 4a, and includes a disc 13a with a slit having four slits (through-holes) 13aa, 13ab, 13ac, and 13ad. Further, the opening angle detection section 13 includes a light-transmitting section 13b for radiating laser light L, a light-receiving section 13c for receiving the laser light L, and a light-receiving position detection sensor 13d for detecting a light-receiving position based on a light-receiving result from the light-receiving section 13c. Further, the light-transmitting section 13b and the light-receiving section 13c are placed so as to be opposed to each other with the disc 13a with a slit.

As illustrated in FIG. 7B, in the disc 13a with a slit, the four slits 13aa to 13ad are formed at positions with different distances from a center O of the rotation shaft 4a so as to pass through the disc 13a with a slit in a thickness direction (direction perpendicular to the drawing surface of the figure) of the disc 13a with a slit. That is, in the disc 13a with a slit, a radius “ra” between the center of the slit 13aa and the center O, a radius “rb” between the center of the slit 13ab and the center O, a radius “rc” between the center of the slit 13ac and the center o, and a radius “rd” between the center of the slit 13ad and the center O are determined so as to decrease in values in this order. Further, the disc 13a with a slit is configured so that, for example when the opening angle is 10°, 30°, 90°, and 150°, the laser light L passes through the slits 13aa, 13ab, 13ac, and 13ad, respectively.

With the above-mentioned configuration, the opening angle detection section 13 is configured so that the rotation angle of the rotation shaft 4a, i.e., the above-mentioned opening angle can be detected. That is, in the opening angle detection section 13, when the light-transmitting section 13b transmits the laser light L, the light-receiving position of the laser light L received by the light-receiving section 13c varies depending upon the slits 13aa to 13ad through which the laser light L has passed. Therefore, the light-receiving position detection sensor 13d detects the light-receiving position of the laser light L in the light-receiving section 13c, whereby a slit through which the laser light L has passed is detected, and an opening angle is detected.

Specifically, when the light-receiving position detection sensor 13d determines that the laser light L has passed through the slit 13aa, the light-receiving position detection sensor 13d detects that the opening angle is 10°. Then, the detection result of the opening angle is output from the opening angle detection section 13 to the main control section 9. Then, in the main control section 9, an image signal is selected so that the display information in the display section 5 becomes display information corresponding to the opening angle θ of 10°, for example, based on a program of an application that is being executed, and the image signal is output to the image processing section 12a and the viewing angle control section 12c is notified of the detected opening angle θ of 10°. After that, the image processing section 12a and the viewing angle control section 12c drive the liquid crystal display device 14 and the viewing angle control device 15, respectively.

Further, when the light-receiving position detection sensor 13d determines that the laser light L has passed through the slit 13ab, the light-receiving position detection sensor 13d detects that the opening angle is 30°. Then, the detection result of the opening angle is output from the opening angle detection section 13 to the main control section 9. Then, in the main control section 9, an image signal is selected so that the display information in the display section 5 becomes display information corresponding to the opening angle θ of 30°, for example, based on a program of an application that is being executed, the image signal is output to the image processing section 12a, and the viewing angle control section 12c is notified of the detected opening angle θ of 30°. After that, the image processing section 12a and the viewing angle control section 12c drive the liquid crystal display device 14 and the viewing angle control device 15, respectively.

Further, when the light-receiving position detection sensor 13d determines that the laser light L has passed through the slit 13ac, the light-receiving position detection sensor 13d detects that the opening angle is 90°. Then, the detection result of the opening angle is output from the opening angle detection section 13 to the main control section 9. Then, in the main control section 9, an image signal is selected so that the display information in the display section 5 becomes display information corresponding to the opening angle θ of 90°, for example, based on a program of an application that is being executed, the image signal is output to the image processing section 12a, and the viewing angle control section 12c is notified of the detected opening angle θ of 90°. After that, the image processing section 12a and the viewing angle control section 12c drive the liquid crystal display device 14 and the viewing angle control device 15, respectively.

Further, when the light-receiving position detection sensor 13d determines that the laser light L has passed through the slit 13ad, the light-receiving position detection sensor 13d detects that the opening angle is 150°. Then, the detection result of the opening angle is output from the opening angle detection section 13 to the main control section 9. Then, in the main control section 9, an image signal is selected so that the display information in the display section 5 becomes display information corresponding to the opening angle θ of 150°, for example, based on a program of an application that is being executed, the image signal is output to the image processing section 12a, and the viewing angle control section 12c is notified of the detected opening angle θ of 150°. After that, the image processing section 12a and the viewing angle control section 12c drive the liquid crystal display device 14 and the viewing angle control device 15, respectively.

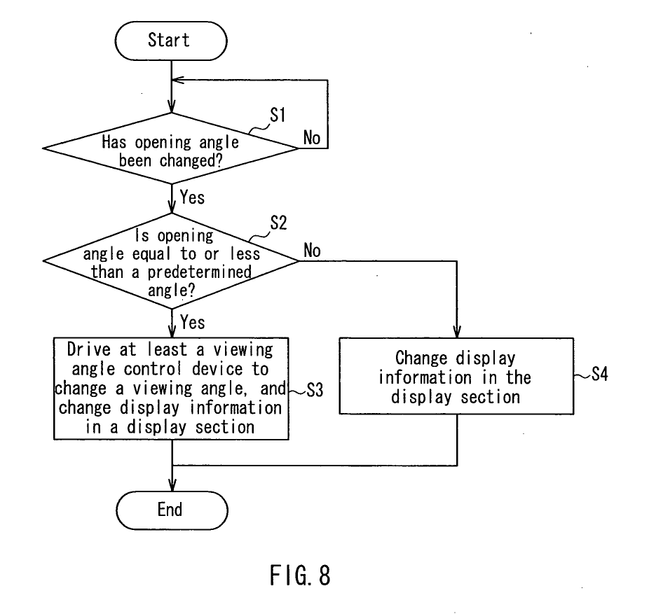

An operation of the PDA 1 of the present embodiment configured as described above will be described specifically with reference to FIG. 8. In the following description, the display operation of the display section 5, for example, in the case where a game function is being executed will be described mainly.

FIG. 8 is a flowchart illustrating an operation example of the PDA.

As shown in Step Si of FIG. 8, in the PDA 1 of the present embodiment, the opening angle detection section 13 performs an opening angle detection step of detecting an opening angle θ and outputs the detected opening angle θ to the main control section 9. Then, the main control section 9 determines whether or not the opening angle θ has been changed. If the main control section 9 determines that the opening angle θ has not been changed, the main control section 9 does not change the display information in the display section 5.

On the other hand, in Step S1, when the main control section 9 determines that the viewing angle θ has been changed, the main control section 9 determines whether or not the changed opening angle θ is a predetermined angle or less (Step S2). Then, when the main control section 9 determines that the changed opening angle θ is a predetermined angle or less, the main control section 9 reads an image signal corresponding to the changed opening angle θ from the storage section 10 based on a program of a game that is being executed, and outputs the image signal and the changed opening angle θ to the display control section 12.

Then, in the display control section 12, a display information change step including a viewing angle change step is performed (Step S3). Specifically, in the display control section 12, the image processing section 12a drives the liquid crystal display device 14 based on the input image signal, and the viewing angle control section 12c drives the viewing angle control device 15 based on the changed opening angle θ to set the viewing angle of the display section 5 in the opening direction to be a narrow viewing angle (diagonal viewing angle). Consequently, in the display section 5, even when the opening angle θ is a very small angle of 10° or 30°, the user can visually identify, for example, the display information of the box Ga illustrated in FIG. 3A, when the user sees the display section 5 in the direction indicated by the arrow “a” in FIG. 2A.

On the other hand, in Step S2, when the main control section 9 determines that the changed opening angle θ exceeds the predetermined angle, the main control section 9 reads an image signal corresponding to the changed opening angle θ from the storage section 10 based on a program of a game that is being executed, and outputs the image signal and the change opening angle θ to the display control section 12.

Then, in the display control section 12, a display information change step is performed (Step S4). In the display information change step in Step S4, the viewing angle change step may or may not be performed. The case where the viewing angle change step is performed will be illustrated. In the display control section 12, the image processing section 12a drives the liquid crystal display device 14 based on an input image signal, and the viewing angle control section 12c drives the viewing angle control device 15 based on the changed opening angle θ to set the viewing angle of the display section 5 in an opening direction to be a wide viewing angle. Consequently, in the display section 5, when the user sees the display section 5 in a direction indicated by an arrow “b” in FIG. 2B, the user can visually identify, for example, display information of the box Gb illustrated in FIG. 3B.

In addition to the above-mentioned description, for example, in the case where an electronic dictionary function is executed by the PDA 1, an English word and a Japanese translation thereof are displayed on the display section 5 when the opening angle θ is 10°, and a phonetic symbol of the English word is displayed on the display section 5 when the opening angle θ is 30°. Further, a sentence example using the English word may be displayed on the display section 5 when the opening angle θ is 90°, and a synonym of the English word may be displayed on the display section 5 when the opening angle θ is 150°.

In the PDA 1 of the present embodiment configured as described above, the rotating mechanism 4 for changing the opening angle θ between the first case (lid section) 2 and the second case 3 containing the display section 5 is provided, and the opening angle detection section 13 for detecting the opening angle θ is set. Further, in the PDA 1 of the present embodiment, the display control section (control unit) 12 for changing display information displayed on the display section 5 is set based on the detection result from the opening angle detection section 13. Thus, in the PDA 1 of the present embodiment, the user can easily change the display information in the display section 5 by rotating at least one of the display section 5 and the second case 3 without performing a button operation, etc. As a result, in the present embodiment, unlike the above-mentioned conventional example, the PDA 1 capable of enhancing the function of an application easily can be configured using information display with respect to the user.

Further, in the present embodiment, the display device 14 and the viewing angle control device 15 are included in the display section 5, and the display control section 12 changes at least one of the information displayed by the display device 14 and the viewing angle controlled by the viewing angle control device 15, based on the detection result from the opening angle detection section 13. Thus, in the present embodiment, even when the opening angle θ is small, the display information in the display section 5 can be changed exactly so as to be identified visually by the user. Further, as shown in Step S3 of FIG. 8, the display control section 12 drives at least the viewing angle control device 15 to change the viewing angle of the display section 5 and change the display information in the display section 5, in the case where the detected opening angle θ is the predetermined angle or less. Therefore, in the case where the opening angle θ is the predetermined angle or less, the user is allowed to recognize visually the display information in the display section 5 exactly.

Further, in the present embodiment, the opening angle detection section 13 includes an angle sensor detecting the rotation angle of the rotation shaft 4a as an opening angle, and hence, the opening angle detection section 13 can detect the opening angle θ precisely with the angle sensor.

In the above description, the case where the angle sensor utilizing laser light is included in the opening angle detection section is described. However, the angle sensor of the present embodiment is not limited thereto, and for example, an angle sensor utilizing light from a light-emitting diode can also be used in place of laser light. Further, another sensor such as a magnetic sensor whose output changes can also be used as an angle sensor, in accordance with the rotation angle (i.e., an opening angle θ) of the rotation shaft.

### Embodiment 2

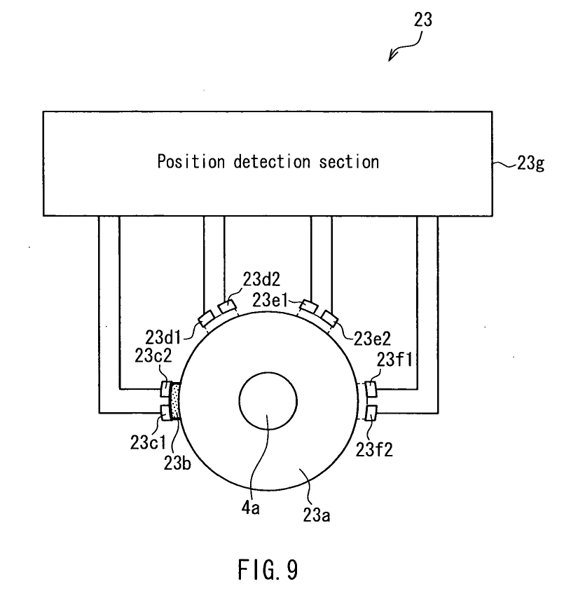

FIG. 9 is a view illustrating a specific configuration example of an opening angle detection section used in a PDA according to Embodiment 2 of the present invention. In the figure, a main difference of the present embodiment from Embodiment 1 lies in that a switch type opening angle detection section is used in place of an angle sensor. The elements common to those in Embodiment 1 are denoted with the same reference numerals as those therein, and repeated descriptions are omitted.

That is, as illustrated in FIG. 9, in the PDA 1 of the present embodiment, a switch-type angle detection mechanism is used in an opening angle detection section 23. Specifically, the opening angle detection section 23 includes a disc 23a provided integrally with the rotation shaft 4a and a bridge member 23b provided on an outer circumferential surface of the disc 23a so as to rotate integrally with the rotation shaft 4a. Further, the opening angle detection section 23 is provided with a plurality of groups (e.g., 4 groups) of pairs of contact members 23c1, 23c2; 23d1, 23d2; 23e1, 23e2; and 23f1, 23f2 provided at positions different from each other along a circumferential direction of the rotation shaft 4a on an outer periphery of the rotation shaft 4a and set so as to come into electrical contact with the bridge member 23b. The pairs of contact members 23c1, 23c2; 23d1, 23d2; 23e1, 23e2; and 23f1, 23f2 are set on an outer periphery of the rotation shaft 4a so as to come into electrical contact with the bridge member 23b, for example, when the opening angle is 10°, 30°, 90°, and 150°.

Further, the opening angle detection section 23 includes a position detection section 23g that is connected to the respective contact members 23c1, 23c2; 23d1, 23d2; 23e1, 23e2; and 23f1, 23f2 and that detects any one group of the contact members 23c1, 23c2; 23d1, 23d2; 23e1, 23e2; and 23f1, 23f2 connected to the bridge member 23b.

With the above-mentioned configuration, the opening angle detection section 23 is configured so that the rotation angle of the rotation shaft 4a, that is, the above-mentioned opening angle can be detected. That is, in the opening angle detection section 23, the position detection section 23g supplies a current from a power source (not shown) to all the pairs of contact members 23c1, 23c2; 23d1, 23d2; 23e1, 23e2; and 23f1, 23f2, and detects a pair of contact members through which a current has flowed via the bridge member 23b, thereby determining the position of the pair of contact members that are in electrical contact with the bridge member 23b and detecting an opening angle.

Specifically, when the position detection section 23g determines that a current has flowed through the pair of contact members 23c1, 23c2, the position detection section 23g detects that the opening angle is 10°. Then, the detection result of the opening angle is output from the opening angle detection section 23 to the main control section 9. Then, in the main control section 9, an image signal is selected so that the display information in the display section 5 becomes the display information corresponding to the viewing angle θ of 10°, for example, based on a program of an application that is being executed and output to the image processing section 12a, and the viewing angle control section 12c is notified of the detected opening angle θ of 10°. After that, the image processing section 12a and the viewing angle control section 12c drive the liquid crystal display device 14 and the viewing angle control device 15, respectively.

Further, when the position detection section 23g determines that a current has flowed through the pair of contact members 23d1, 23d2, the position detection section 23g detects that the opening angle is 30°. Then, the detection result of the opening angle is output from the opening angle detection section 23 to the main control section 9. Then, in the main control section 9, an image signal is selected so that the display information in the display section 5 becomes the display information corresponding to the viewing angle θ of 30°, for example, based on a program of an application that is being executed and output to the image processing section 12a, and the viewing angle control section 12c is notified of the detected opening angle θ of 30°. After that, the image processing section 12a and the viewing angle control section 12c drive the liquid crystal display device 14 and the viewing angle control device 15, respectively.

Further, when the position detection section 23g determines that a current has flowed through the pair of contact members 23e1, 23e2, the position detection section 23g detects that the opening angle is 90°. Then, the detection result of the opening angle is output from the opening angle detection section 23 to the main control section 9. Then, in the main control section 9, an image signal is selected so that the display information in the display section 5 becomes the display information corresponding to the viewing angle θ of 90°, for example, based on a program of an application that is being executed and output to the image processing section 12a, and the viewing angle control section 12c is notified of the detected opening angle θ of 90°. After that, the image processing section 12a and the viewing angle control section 12c drive the liquid crystal display device 14 and the viewing angle control device 15, respectively.

Further, when the position detection section 23g determines that a current has flowed through the pair of contact members 23f1, 23f2, the position detection section 23g detects that the opening angle is 150°. Then, the detection result of the opening angle is output from the opening angle detection section 23 to the main control section 9. Then, in the main control section 9, an image signal is selected so that the display information in the display section 5 becomes the display information corresponding to the viewing angle θ of 150°, for example, based on a program of an application that is being executed and output to the image processing section 12a, and the viewing angle control section 12c is notified of the detected opening angle θ of 150°. After that, the image processing section 12a and the viewing angle control section 12c drive the liquid crystal display device 14 and the viewing angle control device 15, respectively.

With the above-mentioned configuration, the present embodiment can have the function and effects similar to those of Embodiment 1. Further, in the present embodiment, the opening angle detection section 23 can detect the above-mentioned opening angle precisely based on the position of the pair of contact members that are in electrical contact with the bridge member 23b.

In the above description, although the configuration is described in which the bridge member is provided on an outer circumferential surface of the disc provided integrally with the rotation shaft, the bridge member may be set so as to rotate integrally with the rotation shaft on an outer circumferential surface side of the rotation shaft, and for example, the bridge member may be provided directly on the outer circumferential surface of the rotation shaft without providing the disc.

### Embodiment 3

FIG. 10 is a perspective view illustrating a PDA according to Embodiment 3 of the present invention. FIGS. 11A and 11B are side views of the PDAillustrated in FIG. 10 in a state where the first and second cases illustrated in FIG. 10 are opened at different opening angles. In the figures, a main difference of the present embodiment from Embodiment 1 lies in that the above-mentioned display section is configured as a first display section, and a second display section configured so as to display information independently from the first display section is accommodated in the first case. The elements common to those of Embodiment 1 are denoted with the same reference numerals as those therein, and descriptions thereof are omitted.

That is, as illustrated in FIG. 10, in a PDA 31 of the present embodiment, the display section 5 provided in the second case 3 is configured as a first display section (hereinafter, referred to as a “first display section 5”). Further, in the PDA 31, a second display section 33 as a second display section, which is configured so as to display information independently from the first display section 5, is provided in a first case 32 as a lid section.

Further, in the PDA 31 of the present embodiment, the first and second cases 32, 3 are configured so as to rotate relatively via the rotating mechanism 4 in the same way as in Embodiment 1. More specifically, in the PDA 31 of the present embodiment, an end portion 32a of the first case 32 and end portions 3a of the second case 3 are integrally attached to the rotation shaft 4a (FIG. 11) provided in the rotating mechanism 4, and the first and second cases 32, 3 can rotate about the rotation shaft 4a of the rotating mechanism 4 configured in a hinge structure. Then, in the PDA 31 of the present embodiment, the first and second cases 32, 3 can be opened/dosed (folded) via the rotating mechanism 4.

Specifically, as illustrated in FIGS. 11A and 11B, the PDA 31 of the present embodiment can be configured so as to be used while the first and second cases 32, 3 are opened at an opening angle θ. The opening angle is an angle between the surface of the first case 32 and the surface of the second case 3, and specific values of an angle range of the opening angle θ is, for example, 0° to 150°. Further, in the PDA 31, when the value of the opening angle θ is 0°, that is, in the case where the first and second cases 32, 3 are dosed (folded) so that the surface of the first case 32 and the surface of the second case 3 are in contact with each other, the PDA 31 is not used.

The second display section 33 includes a display surface 33a provided in a direction perpendicular to the rotation shaft 4a (FIG. 11) so that the information is displayed on the display surface 33a. Further, in the same way as in the first display section 5, the second display section 33 includes a display device for information display for displaying information and a viewing angle control device for viewing angle control for controlling a viewing angle, and is configured so as to change (control) a viewing angle.

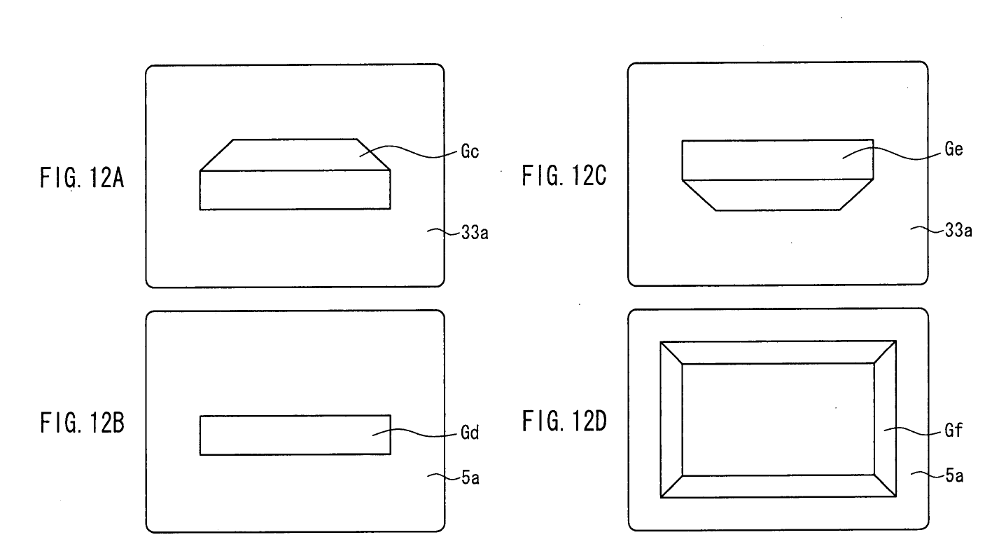

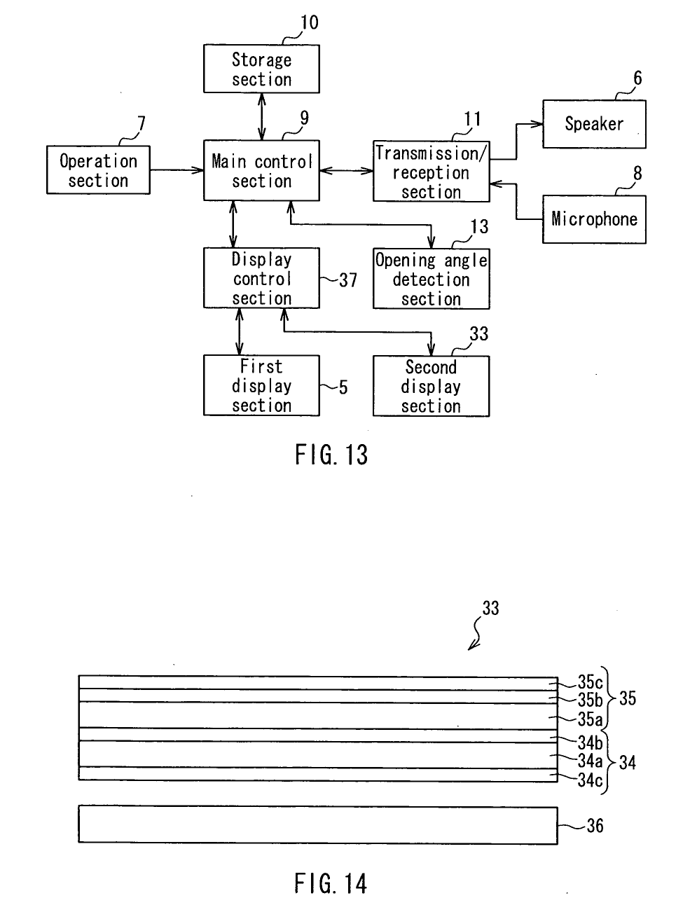

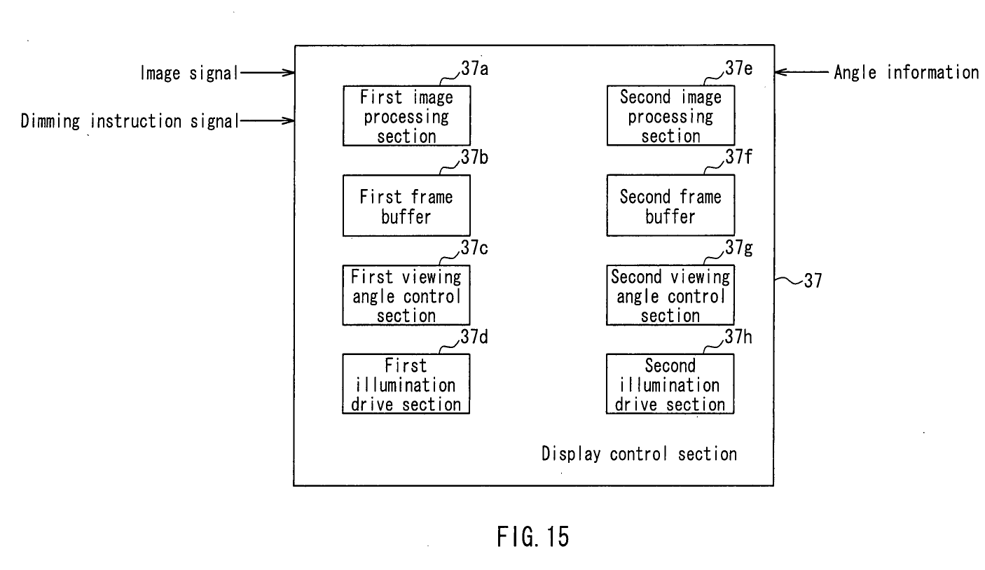

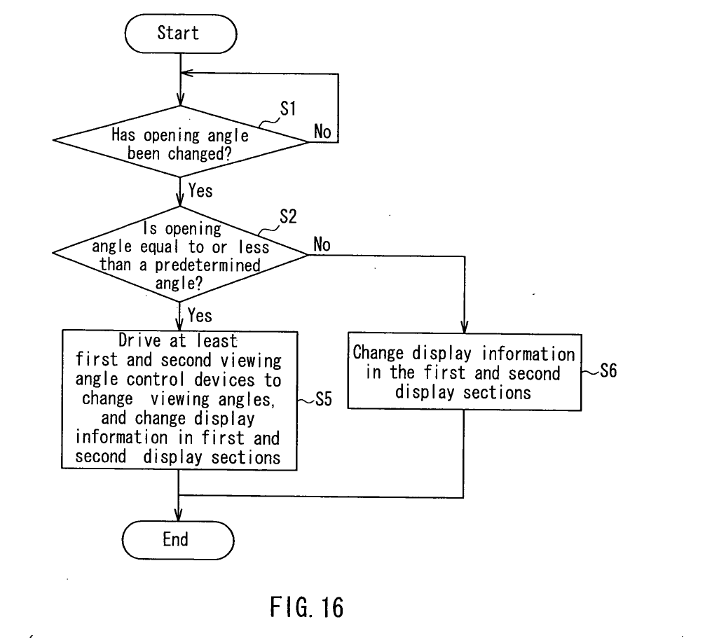

Further, in the PDA 31 of the present embodiment, in the same way as in that of Embodiment 1, the opening angle θ is detected automatically by the opening angle detection section 13, and display information displayed on the first and second display sections 5, 33 can be changed depending upon the detected opening angle θ. Specifically, as illustrated in FIG. 11A, when the user sees the display surface 33a of the second display section 33 from a direction indicated by an arrow “c” in FIG. 11A in the case where the first and second cases 32, 3 are opened at a relatively small opening angle θ, a lid Gc is displayed on the display surface 33a, as illustrated in FIG. 12A. Further, when the user sees the display surface 5a of the first display section 5 from a direction indicated by an arrow “d” in FIG. 11A, a box Gd with a lid closed is displayed on the display surface 5a, as illustrated in FIG. 12B.

On the other hand, as illustrated in FIG. 11B, when the user sees the display surface 33a of the second display section 33 from a direction indicated by an arrow “e” in FIG. 11B in the case where the first and second cases 32, 3 are opened at a relatively large opening angle θ, the lid Ge that is about to be opened as illustrated in FIG. 12C is displayed on the display surface 33a. Further, when the user sees the display surface 5a of the first display section 5 from a direction indicated by an arrow “f” in FIG. 11B, a box Gf with an inside thereof shown is displayed on the display surface 5a as illustrated in FIG. 12D.

Hereinafter, the PDA 1 of the present embodiment will be described specifically with reference to FIGS. 13 to 15.

FIG. 13 is a block diagram illustrating configurations of main portions of the PDA illustrated in FIG. 10. FIG. 14 is a view illustrating a specific configuration example of the second display section. FIG. 15 is a block diagram illustrating a specific configuration example of the display control section illustrated in FIG. 13.

First, the configurations of the main portions of the PDA 31 of the present embodiment will be described with reference to FIG. 13.

As illustrated in FIG. 13, unlike Embodiment 1 illustrated in FIG. 4, the PDA 31 of the present embodiment is provided with a display control section 37 for driving each of the first and second display sections 5, 33. The display control section 37 is connected to the main control section 9 and is adapted to drive each of the first and second display sections 5, 33 based on an instruction signal from the main control section 9. Further, the display control section 37 constitutes a control unit changing display information &splayed on each of the first and second display sections 5, 33, based on the detection result from the opening angle detection section 13. That is, the display control section 37 is adapted to drive at least one of the display device and the viewing angle control device included in each of the first and second display sections 5, 33 in accordance with the opening angle θ detected by the opening angle detection section 13 to change the display information on the respective first and second display sections 5, 33.

Further, the display control section 37 is configured so as to drive at least the viewing angle control device included in each of the first and second display sections 5, 33 in the case where the opening angle θ detected by the opening angle detection section 13 is a predetermined angle (e.g.,)30° or less to change the viewing angle of each of the first and second display sections 5, 33.

Next, a specific configuration of the second display section 33 will be described with reference to FIG. 14.

As illustrated in FIG. 14, the second display section 33 includes a liquid crystal display device 34 as the above-mentioned display device, the viewing angle control device 35 provided integrally with the liquid crystal display device 34 and placed on the display surface 33a (FIG. 10) side, and an illumination device 36 radiating predetermined illumination light to the liquid crystal display device 34.

The liquid crystal display device 34 includes a liquid crystal panel 34a for display, and a pair of polarizing plates 34b and 34c provided respectively on the display surface side and the non-display surface side of the liquid crystal panel 34a. The liquid crystal panel 34a includes a display surface that displays information containing characters and images and substantially constitutes the display surface 33a. Further, the liquid crystal panel 34a is provided with a color filter (not shown) so as to be able to perform a color display.

Further, the liquid crystal panel 34a may have any liquid crystal mode and pixel structure. The liquid crystal panel 34a may have any drive mode. That is, as the liquid crystal panel 34a, any liquid crystal panel capable of displaying information can be used. Therefore, in FIG. 14, the detailed structure of the liquid crystal panel 34a is not illustrated, and the description thereof is omitted.

The viewing angle control device 35 includes a liquid crystal panel 35a for controlling a viewing angle, placed on the polarizing plate 34b, and a retardation plate 35b and a polarizing plate 35c laminated successively on the liquid crystal panel 35a.

The liquid crystal panel 35a includes a liquid crystal layer and a pair of light-transparent substrate sandwiching the liquid crystal layer (not shown). Further, in the liquid crystal panel 35a, unlike the liquid crystal panel 34a, it is not necessary to drive a liquid crystal layer on a pixel basis, and hence, there is no constraint to the electrode structure. That is, in the liquid crystal panel 35a, in order to perform uniform switching over the entire display surface, uniform transparent electrodes may be formed over the entire surface of the light-transparent substrate, or any electrode structure may be taken.

Further, the viewing angle control device 35 is configured so as to change a viewing angle of the second display section 33 in an opening direction, in cooperation with the polarizing plate 34b of the liquid crystal display device 34. That is, the polarizing plates 35c and 34b are placed so that the respective polarization transmission axes are substantially orthogonal to each other (for example, in a range of 80° to)100°.

Specifically, when a voltage is applied to the liquid crystal panel 35a in the viewing angle control device 35, liquid crystal molecules (not shown) in the liquid crystal layer provided in the liquid crystal panel 35a tilt depending upon the magnitude of the applied voltage. Thus, in the second display section 33, the viewing angle is changed, and hence, even when the first and second cases 32, 3 are opened at a very small opening angle θ equal to or less than a predetermined angle (30° or less), the user can visually identify and read the information displayed on the second display section 33. That is, for example, even in the case where the user visually identifies the second display section 33 in the direction indicated by the arrow “c” in FIG. 11A, the viewing angle control device 35 controls (changes) the viewing angle of the second display section 33 appropriately, whereby the user can determine the information displayed on the display section 5.

On the other hand, in the case where a voltage is not applied to the liquid crystal panel 35a, when a birefringence sufficient for obtaining a satisfactory display with respect to every direction from the display surface 33a is generated in the liquid crystal panel 35a, the second display section 33 is allowed to have a large viewing angle.

As described above, in the second display section 33 of the present embodiment, the viewing angle of the second display section 33 can be changed by switching application/non-application of a voltage to the liquid crystal panel 35a.

The illumination device 36 is formed of, for example, an edge light type backlight having an LED (not shown) as a light source and a light guide plate (not shown) that guides light from the LED in a predetermined direction and outputs the light as illumination light to the liquid crystal display device 34 side.

Next, a specific configuration of the display control section 37 will be described with reference to FIG. 15.

As illustrated in FIG. 15, the display control section 37 is adapted to receive an image signal, a dimming instruction signal, and angle information from the main control section 9 (FIG. 13). Further, the display control section 37 includes a first image processing section 37a, a first frame buffer 37b, a first viewing angle control section 37c, and a first illumination drive section 37d that drive each part of the first display section 5, and a second image processing section 37e, a second frame buffer 37f, a second viewing angle control section 37g, and a second illumination drive section 37h that drive each part of the second display section 33.

Specifically, in the display control section 37, the first image processing section 37a performs predetermined image processing with respect to an input image signal, thereby generating and outputting an instruction signal to the liquid crystal panel 14a (FIG. 5) of the liquid crystal display device 14. Thus, in the liquid crystal panel 14a, information display in accordance with an image signal is performed. Further, in the display control section 37, the second image processing part 37e performs predetermined image processing with respect to an input image signal, thereby generating and outputting an instruction signal to the liquid crystal panel 34a (FIG. 14) of the liquid crystal display device 34. Thus, in the liquid crystal panel 34a, information display in accordance with an image signal is performed.

Further, the display control section 37 is configured so that the first and second image processing sections 37a, 37e can change information displayed respectively by the liquid crystal display devices 14, 34, based on the detection result from the opening angle detection section 13. That is, in the main control section 9, an image signal is changed appropriately to be output to the display control section 37 in accordance with the detection result from the opening angle detection section 13, and the respective first and second image processing sections 37a, 37e allow the corresponding liquid crystal panels 14a, 34a to display information in accordance with the detection result.

Further, in the display control section 37, the first and second viewing angle control sections 37c, 37g respectively drive the viewing angle control devices 15, 35 so that the viewing angles of the first and second display sections 5, 33 are changed depending upon the opening angle θ detected by the opening angle detection section 13. Further, in the display control section 37, the first and second illumination drive sections 37d, 37h are configured so as to change respectively the brightness of illumination light output from the illumination devices 16, 36 in accordance with the input dimming instruction signal, and information display can be performed on the first and second display sections 5, 33 at a brightness desired by the user.

The operation of the PDA 31 of the present embodiment configured as described above will be described specifically with reference to FIG. 16. In the following description, for example, display operations of the respective first and second display sections 5, 33 in the case where a game function is being executed will be described mainly.

FIG. 16 is a flowchart illustrating an operation example of the PDA illustrated in FIG. 10.

As shown in Step S1 of FIG. 16, in the PDA 31 of the present embodiment, the opening angle detection section 13 performs an opening angle detection step of detecting an opening angle θ and outputs the detected opening angle θ to the main control section 9. Then, the main control section 9 determines whether or not the opening angle θ has been changed. If the main control section 9 determines that the opening angle θ has not been changed, the main control section 9 does not change the display information in each of the first and second display sections 5, 33.

On the other hand, in Step S1, when the main control section 9 determines that the viewing angle θ has been changed, the main control section 9 determines whether or not the changed opening angle θ is a predetermined angle or less (Step S2). Then, when the main control section 9 determines that the changed opening angle θ is a predetermined angle or less, the main control section 9 reads an image signal corresponding to the changed opening angle θ from the storage section 10 based on a program of a game that is being executed, and outputs the image signal and the changed opening angle θ to the display control section 37.

Then, in the display control section 37, a display information change step induding a viewing angle change step is performed (Step S3). Specifically, in the display control section 37, the first and second image processing sections 37a, 37e drive the liquid crystal display devices 14, 34 respectively based on the input image signal. Further, the first and second viewing angle control sections 37c, 37g drive the viewing angle control devices 15, 35 respectively based on the changed opening angle θ to set the viewing angles of the respective first and second display sections 5, 33 in the opening direction to be narrow viewing angles (diagonal viewing angles). Consequently, in the first and second display sections 5, 33, even when the opening angle θ is a very small angle of 10° or 30°, the user can visually identify, for example, the display information of the lid Gc illustrated in FIG. 12A and display information of the lid Ge illustrated in FIG. 12C, when the user sees the first and second display sections 5, 33 respectively in the direction indicated by the arrows “c”, “d” in FIG. 11A.

On the other hand, in Step S2, when the main control section 9 determines that the changed opening angle θ exceeds a predetermined angle, the main control section 9 reads an image signal corresponding to the changed opening angle θ from the storage section 10 based on a program of a game that is being executed, and outputs the image signal and the change opening angle θ to the display control section 37.

Then, in the display control section 37, a display information change step is performed (Step S4). In the display information change step in Step S4, the viewing angle change step may or may not be performed. The case where the viewing angle change step is performed will be illustrated. In the display control section 37, the first and second image processing sections 37a, 37e drive the liquid crystal display devices 14, 34 respectively based on an input image signal. Further, the first and second viewing angle control sections 37c, 37g drive the viewing angle control devices 15, 35 respectively based on the changed opening angle θ to set the viewing angle of each of the first and second display sections 5, 35 in an opening direction to be wide viewing angles. Consequently, in the first and second display sections 5, 33, when the user sees the first and second display sections 5, 33 in directions indicated by arrows “e”, “f” in FIG. 11B, the user can visually identify, for example, display information of the box Gb illustrated in FIG. 12B and display information of the box Gf illustrated in FIG. 12D.

With the above-mentioned configuration, in the present embodiment, the function and effects similar to those of Embodiment 1 can be exhibited. Further, in the present embodiment, since the second display section 33 is provided, the function of an application can be enhanced exactly using the display information in the second display section 33. Further, in the present embodiment, the first and second display sections 5, 33 configured so as to display information independently from each other are provided. Therefore, the function of an application can be further enhanced easily, using the respective first and second display sections 5, 33.

The above embodiments are all shown for illustrative purposes and are not limiting. The technical range of the present invention is defined by the scope of claims, and the configuration recited in the claims and all the changes within the equivalent range are included in the technical range of the present invention.

For example, in the above description, the case of applying the present invention to a personal digital assistant (PDA) has been described. However, the portable terminal of the present invention is not limited thereto. That is, the portable terminal of the present invention is not limited as long as it is a portable terminal having a display section for displaying information, including a lid section provided so as to be opened/dosed with respect to the display section, a rotating mechanism that is provided with a rotation shaft to which at least one of a display section and a lid section is attached integrally so that the display section and the lid section can rotate relative to each other, and that changes an opening angle between the display section and the lid section by rotating at least one of the display section and the lid section; an opening angle detection section for detecting an opening angle; and a control section that changes display information to be displayed on the display section based on a detection result from the opening angle detection section. Specifically, the present invention can be applied to various portable terminals such as a mobile telephone, a portable game (dedicated) machine, and an electronic dictionaries.

Further, in the description of each of the first and second embodiments, the configuration in which the end portion of the second housing containing the end portion of the first case (lid section) and the display section is attached integrally to the rotation shaft of the rotating mechanism is described. Further, in the description of Embodiment 3, the configuration in which the end portion of the first case (lid section) containing the second display section and the end portion of the second case containing the first display section are attached integrally to the rotation shaft of the rotating mechanism is described. However, the portable terminal of the present invention is not limited thereto, and at least one of the display section and the lid section may be attached integrally to the rotation shaft so that the display section and the lid section can rotate relative to each other.

Further, in the above description, the configuration is described in which the main control section and the display control section are provided separately, and the display control section drives each of the display device of the display section and the viewing angle control device. However, the present invention is not limited thereto, and the main control section and the display control section may be configured integrally, and each of the display device and the viewing angle control device may be driven using the detection result from the opening angle detection section.

Further, in the above description, the configuration is described in which the opening angle detection section detects four opening angles of 10°, 30°, 90°, and 150° in stages. However, the present invention is not limited thereto. For example, a rotary encoder capable of detecting an opening angle continuously is included in the opening angle detection section, and an opening angle may be detected on a predetermined unit basis (e.g., on the basis of 1°).

Further, in the above description, the case is described in which each of the first and second display sections includes a display device for information display for displaying information and a viewing angle control device for viewing angle control for controlling a viewing angle, and a liquid crystal panel is used in each of the display device and the viewing angle control device. However, the present invention is not limited thereto. Specifically, for example, a display device including another display panel such as an organic electronic luminescence (EL) element can also be sued. Further, a viewing angle control device using a parallax element including a parallax barrier and a lenticular lens can also be used.

It is preferred to use a liquid crystal panel in each of the display device and the viewing angle control device as in each embodiment, since a compact portable terminal of high performance can be configured easily.

### INDUSTRIAL APPLICABILITY

The present invention is useful for a portable terminal capable of enhancing the function of an application easily using information display with respect to a user, and a method for driving the portable terminal.

### DESCRIPTION OF REFERENCE NUMERALS

1, 31 PDA (portable terminal)

2, 32 first case (lid section)

3 second case

4 rotating mechanism

4a rotation shaft

5 display section (first display section)

12, 37 display control section (control section)

13 opening angle detection section

13a disc with a slit (angle sensor)

13b light-transmitting section (angle sensor)

13c light-receiving section (angle sensor)

13d light-receiving position detection sensor (angle sensor)

14 liquid crystal display device (display device)

14a liquid crystal panel

15 viewing angle control device

15a liquid crystal panel

23 opening angle detection section

23b bridge member

23c1, 23c2, 23d1, 23d2, 23e1, 23e2, 23f1, 23f2 pairs of contact members

33 display section (second display section)

34 liquid crystal display device (display device)

34a liquid crystal panel

35 viewing angle control device

35a liquid crystal panel

1. A portable terminal having a display section for displaying information, comprising:
a lid section provided so as to be opened/closed with respect to the display section;
a rotating mechanism that is provided with a rotation shaft to which at least one of the display section and the lid section is attached integrally so that the display section and the lid section are capable of rotating relative to each other and that changes an opening angle between the display section and the lid section by rotting at least one of the display section and the lid section;
an opening angle detection section for detecting the opening angle; and
a control section for changing display information displayed on the display section, based on a detection result from the opening angle detection section.

2. The portable terminal according to claim 1, wherein the display section includes a display device for information display for displaying information and a viewing angle control device for viewing angle control for controlling a viewing angle, and
the control section changes at least one of information displayed by the display device and a viewing angle controlled by the viewing angle control device, based on the detection result from the opening angle detection section.

3. The portable terminal according to claim 1, wherein the display section is configured as a first display section, and
the lid section is provided with a second display section configured so as to display information independently from the first display section.

4. The portable terminal according to claim 3, wherein the control section changes display information displayed on the second display section, based on the detection result from the opening angle detection section.

5. The portable terminal according to claim 3, wherein the second display section includes a display device for information display for displaying information and a viewing angle control device for viewing angle control for controlling a viewing angle,
the control section changes at least one of information displayed by the display device included in the second display section and a viewing angle controlled by the viewing angle control device included in the second display section, based on the detection result from the opening angle detection section.

6. The portable terminal according to claim 5, wherein a liquid crystal panel is used in each of the display device and the viewing angle control device in each of the first and second display sections.

7. The portable terminal according to claim 1, wherein the opening angle detection section includes an angle sensor for detecting a rotation angle of the rotation shaft as the opening angle.

8. The portable terminal according to claim 1, wherein the opening angle detection section includes a bridge member set so as to rotate integrally with the rotation shaft on an outer circumferential surface side of the rotation shaft, and a plurality of groups of pairs of contact members provided at positions different from each other along a circumferential direction of the rotation shaft on an outer periphery of the rotation shaft and set so as to come into electrical contact with the bridge member.

9. A method for driving a potable terminal including a display section for displaying information, a lid section provided so as to be opened/closed with respect to the display section, and a rotating mechanism that is provided with a rotation shaft to which at least one of the display section and the lid section is attached integrally so that the display section and the lid section are capable of rotating relative to each other and that changes an opening angle between the display section and the lid section by rotating at least one of the display section and the lid section, the method comprising:
an opening angle detection step of detecting the opening angle; and
a display information change step of changing display information displayed on the display section, based on the opening angle detected in the opening angle detection step.

10. A method for driving a portable terminal according to claim 9, wherein the display information change step includes a viewing angle change step of changing a viewing angle of the display section.

11. A driving program of a portable terminal for causing a computer to execute a method for driving a portable terminal including a display section for displaying information, a lid section provided so as to be opened/closed with respect to the display section, and a rotating mechanism that is provided with a rotation shaft to which at least one of the display section and the lid section is attached integrally so that the display section and the lid section are capable of rotating relative to each other and that changes an opening angle between the display section and the lid section by rotating at least one of the display section and the lid section, the program causing the computer to execute:
an opening angle detectiOn step of detecting the opening angle; and
a display information change step of changing display information displayed on the display section, based on the opening angle detected in the opening angle detection step.

12. The driving program of a portable terminal according to claim 11, wherein the display information change step includes a viewing angle change step of changing a viewing angle of the display section.
